(19) United States
(12) Patent Application Publication
(10) Pub. No.: US 2010/0008299 A1
(43) Pub. Date: Jan. 14, 2010

(54) IP CONVERGED MOBILE ACCESS GATEWAY FOR 3G MOBILE SERVICE AND SERVICE METHOD USING THE SAME

(75) Inventors: Dong-Jin Shin, Daejon (KR); Young-Jick Bahg, Daejon (KR); Yeong-Jim Kim, Daejon (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejon (KR); SAMSUNG ELECTRONICS CO.,LTD., Suwon-si (KR)

(21) Appl. No.: 12/517,770

(22) PCT Filed: Dec. 3, 2007
(86) PCT No.: PCT/KR2007/006205

§ 371 Date: Jun. 4, 2009

(30) Foreign Application Priority Data
Dec. 7, 2006 (KR) 10-2006-0124032
Aug. 21, 2007 (KR) 10-2007-0083980

(51) Int. Cl. H04W 88/16; H04L 12/56

(52) U.S. Cl. 370/328; 370/401

(57) ABSTRACT

Provided are an Internet protocol (IP) converged mobile access gateway for a 3rd generation (3G) mobile service and a service method using the same. The IP converged mobile access gateway including: an access controller adapted to exchange a control signal with the base station and perform mobility control for the terminal and session control for a service request; a transport controller adapted to perform routing database information management and routing protocol processing for packet routing; and a transport executor adapted to set a tunnel with the base station for user data transmission according to control information sent from the access controller, configure a packet data convergence protocol (PDCP) for a logical connection with the terminal, and interwork with the transport controller to perform packet routing and forwarding.

### TECHNICAL FIELD

The present invention relates to an Internet protocol (IP) converged mobile access gateway for a 3rd generation (3G) mobile service and a service method using the same; and, more particularly, to an IP converged mobile access gateway for a 3G mobile service, which is usable for a 3G evolution or a post-3G IP mobile access network, and a service method using the same.

More specifically, the present invention relates to an converged mobile access gateway for efficiently providing a 3G evolution IP mobile service in a 3G evolution IP mobile access network by converging IP technologies such as IP packet routing, and mobile access control functions such as efficient transfer of a control signal and a traffic signal, and mobility management and session management with respect to a base station and a terminal, and a service method using the same.

This work was supported by the Information Technology (IT) research and development program of the Korean Ministry of Information and Communication (MIC) and the Korean Institute for Information Technology Advancement (IITA) [2005-S-404-22, “Research and development on 3G long-term evolution access system”].

### BACKGROUND ART

To configure an IP mobile access network, studies on associated technologies are being conducted by organizations including the 3rd Generation Partnership Project (3GPP)/3GPP2, the institute of Electrical and Electronics Engineers (IEEE), and the Internet Engineering Task Force (IETF). Particularly, efforts to standardize a post 3G evolution mobile communications system technology are most actively made in the 3GPP. To provide an IP mobile service, the 3GPP is conducting a study for standardization on technologies associated with system architecture evolution (SAE) for a core network architecture and long term evolution (LTE) for an access network architecture on the basis of three network elements of a core network, an access network and a terminal.

Examples of an IP mobile access network include an IP transport radio access network (IPTRAN) using an IP transport network, and an IP converged radio access network (IPCRAN) where an IP technology and a mobile access control technology are converged.

The IPTRAN is an IP access network at an initial stage. In the IPTRAN, an IP is used for access between network elements while existing mobile network elements such as Node-B/base transceiver station (BTS) or a radio network controller (RNC)/base station controller (BSC) are maintained. The IPTRAN allows the use of an existing system and is enabled just by changing an interface into an IP base, thereby realizing easy application thereof. However, the IPTRAN has limitations in efficiency of network configuration because an Internet technology and a mobile communications technology independently exist.

FIG. 1 is a block diagram of a conventional distributed IP mobile access network.

A network illustrated in FIG. 1 has a configuration where a 3G evolution base station 11, a base station controller (BSC) 13, and a user data transmitter 14 are connected about an IP access network 12. For access to an IP core network, a router 15 is provided as in a general Internet network.

The conventional access network illustrated in FIG. 1 is a general 3G evolution access network, and is characterized in that the BSC 13 and the user data transmitter 14 are separated. The router 15 for IP matching with an external core network is also separated.

Such a conventional access network has flexibility in configuring an IP network, but has limitations in that control information required for access network control cannot be exchanged between the router 15 and the user data transmitter 14 or between the router 15 and the BSC 13, and it operates independently from the router 15. Examples of the control information may include service quality information session information, IP address information of a terminal, and mobility management information thereof. In the conventional access network, the aforementioned information used in an Internet network cannot be exchanged, and must be separately re-generated to be suitable for mobile communication.

Standardization organizations including the 3GPP are conducting many studies on post 3G system technologies to solve the limitations described above and achieve effective convergence of the Internet technology and the mobile communication technology. Those studies are being conducted in order to achieve extensibility and easy reconfiguration and allow flexible system configuration by distributing an access network according to each function by taking advantage of easy networking of the Internet technology.

### DISCLOSURE

### Technical Problem

An embodiment of the present invention is directed to providing an IP converged mobile access gateway in which an Internet technology and a mobile communication technology are organically converged with each other while a distributed characteristic is maintained and an IP is used in configuring a mobile access gateway, which is a component of a post 3G evolution access network, and a service method using the same.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an Internet protocol (IP) converged mobile access gateway for a third-generation (3G) mobile service, which is placed between a base station and an IP core network to provide an IP mobile service to a terminal, the IP converged mobile access gateway including: an access controller adapted to exchange a control signal with the base station and perform mobility control for the terminal and session control for a service request; a transport controller adapted to perform routing database information management and routing protocol processing for packet routing; and a transport executor adapted to set a tunnel with the base station for user data transmission according to control information sent from the access controller, configure a packet data convergence protocol (PDCP) for a logical connection with the terminal, and interwork with the transport controller to perform packet routing and forwarding.

In accordance with another aspect of the present invention, there is provided a service method using an Internet protocol (IP) converged mobile access gateway placed between a base station and an internet protocol (IP) core network and having an access controller, a transport controller and a transport executor, including: at the access controller, performing authentication and security setting in response to a service request of a terminal; at the access controller, requesting the transport executor to set a tunnel in response to a context activation request; at the access controller, requesting the base station to assign a bearer when a tunnel is set at the transport executor; at the access controller, requesting the transport executor to configure a packet data convergence protocol (PDCP) for a logical connection with the terminal in response to a PDCP configuration request of the base station; and at the access controller, sending a PDCP configuration response to the base station, and reporting that the context activation request is accepted when a bearer assignment response is received from the base station.

In accordance with an embodiment of the present invention, a control plane and a user plane are separated, and a mobile communication function and an IP-based function are effectively converged, so that a mobile access network can be efficiently controlled, and a service for a 3G evolution or post 3G base station and terminal using a framing protocol (FP) and a packet data convergence protocol (PDCP) can be effectively supported.

That is, as an IP technology is introduced into a post 3G mobile access network, a mobile communication function and an Internet function are organically converged, so that mobile access can be effectively performed. Particularly, matching with a base station system e.g., a 3G evolution base station which is eNode B or an enhanced base station thereof, which is one of important elements of an access network contributes to effectively providing a service such as mobility control, session control, and a multimedia broadcasting/group transmission service such as multicast broadcast multimedia service (MBMS).

### ADVANTAGEOUS EFFECTS

In the present invention, a framing protocol (FP) and a packet data convergence protocol (PDCP) processing functions, and an IP packet routing function can be effectively converged so as to effectively support 3G evolution and post 3G base stations and terminals. Also, an access control service such as mobility control and session control for a 3G evolution mobile service can be efficiently performed.

### BRIEF DESCRIPTION OF THE DRAWINGS

FIG. 1 is a block diagram of a conventional IP distributed mobile access network.

FIG. 2 is a block diagram of a mobile access network in accordance with an embodiment of the present invention.

FIG. 3 is a block diagram of a mobile access gateway in accordance with an embodiment of the present invention.

FIG. 4 is a block diagram of a transport executor in accordance with an embodiment of the present invention.

FIG. 5 is a block diagram of a transport controller in accordance with an embodiment of the present invention.

FIG. 6 is a block diagram of an access controller in accordance with an embodiment of the present invention.

FIG. 7 is a flow diagram illustrating a service method in accordance with an embodiment of the present invention.

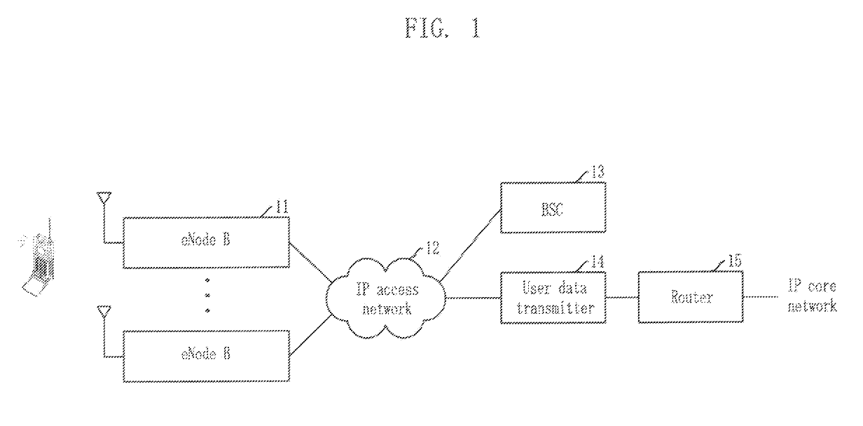

### BEST MODE FOR THE INVENTION

The advantages, features and aspects of the invention will become apparent from the following description of the embodiments with reference to the accompanying drawings, which is set forth hereinafter. Detailed descriptions related to well-known functions or configurations will be ruled out in order not to unnecessarily obscure subject matters of the present invention.

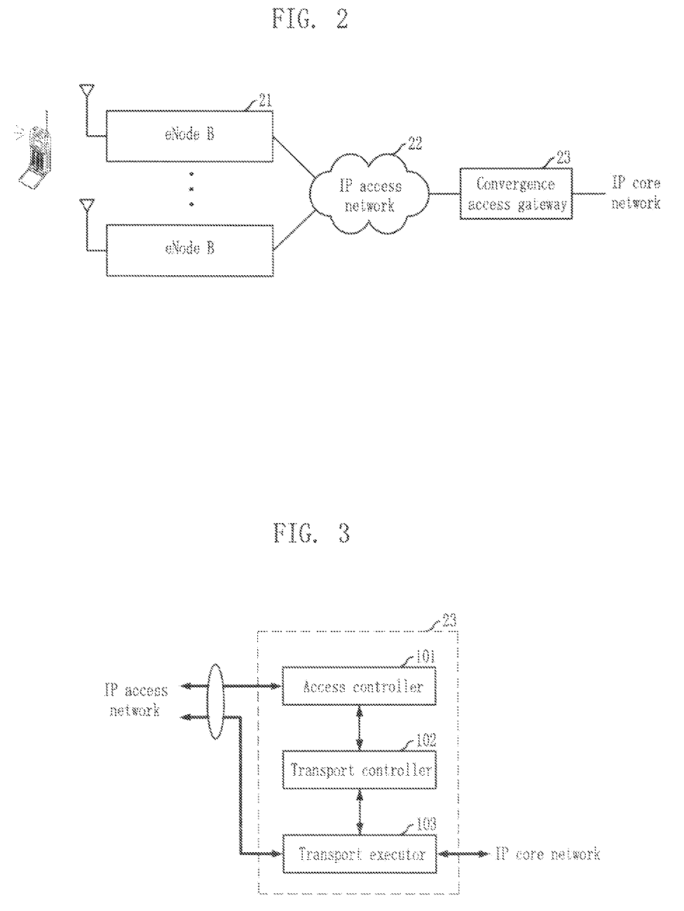

FIG. 2 is a block diagram of an IP converged mobile access network in accordance with an embodiment of the present invention.

Referring to FIG. 2, the IP converged mobile access gateway 23 in accordance with an embodiment of the present invention is placed between an IP access network 22 and an IP core network. The converged access gateway 23 in accordance with an embodiment of the present invention includes an access controller, a transport controller, and a transport executor to converge a mobile communication function and an Internet function together.

The IP converged mobile access gateway in accordance with an embodiment of the present invention contributes to simplifying access network configuration and achieving flexible system extension. Also, the converged access gateway can provide an advanced mobile service to a 3G evolution base station or an enhanced base station thereof and a terminal.

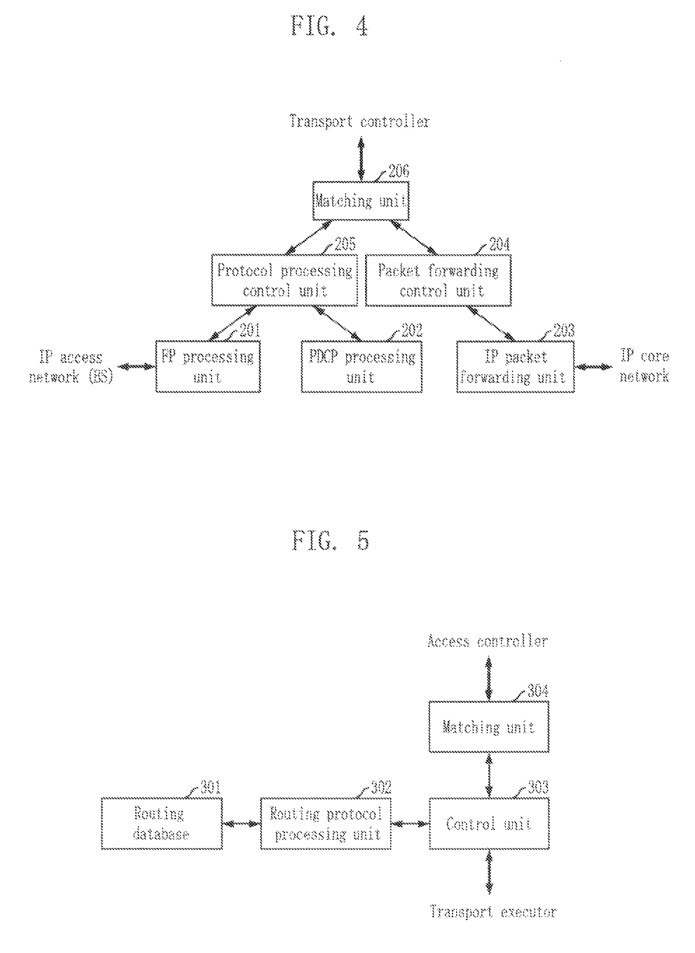

FIG. 3 is a block diagram of an IP converged access gateway in accordance with an embodiment of the present invention.

The converged access gateway 23 in accordance with an embodiment of the present invention includes an access controller 101, a transport controller 102, and a transport executor 103.

For reliable transfer of a control signal to a base station, the access controller 101 performs protocol processing for radio network application, and mobility control and session control. That is, the access controller 101 interworks with the base station to process authentication and security in response to a service request of a terminal, and interworks with the transport controller 102 and the transport executor 103 in response to the service request of the terminal to control tunnel setting and logical configuration of a packet data convergence protocol (PDCP). The access controller performs session control and mobility control for handover of the terminal.

Under the control of the access controller 101, the transport controller 102 controls processing of a framing protocol (FP) operating at the transport executor 102, PDCP processing and packet forwarding, and sends operation information of the transport executor 103 to the access controller 101. The transport controller 102 also performs routing database information management and routing protocol processing for routing.

The transport executor 103 executes an FP required for user data transmission to the base station, performs tunnel setting and management with the base station according to control information of the access controller 101. Also, the transport executor 103 is logically connected to a user terminal to perform PDCP processing for processing compression and extension of a packet header, and packet routing and forwarding. The detailed operations of the access controller 101, the transport controller 102, and the transport executor 103 will be described with reference to FIGS. 4 to 7.

FIG. 4 is a block diagram of a transport executor of an IP converged mobile access gateway in accordance with an embodiment of the present invention.

The transport executor 103 includes an IP packet forwarding unit 203, an FP processing unit 201, a PDCP processing unit 202, a protocol processing control unit 205, a packet forwarding control unit 204, and a matching unit 206 for matching with the transport controller 102 for control-message transfer.

The IP packet forwarding unit 203 performs packet intercept and routing according to routing control information sent from the packet forwarding controller 204. The IP packet forwarding unit 203 performs table management for packet filtering, paging reporting for a received packet, packet buffering, and control message processing for a multimedia packet for broadcasting and group transmission.

For data transmission to a base station, the FP processing unit 201 converts a packet transmitted from the PDCP processing unit 202 into an FP packet according to mobile management information and session management information sent from the protocol processing control unit 205. Then, the FP processing unit 201 sends the FP packet to the base station. Also, the FP processing unit 201 performs tunnel generation, release and management with the base station for a transmission bearer under the control of the protocol processing control unit 205, and performs error processing of the FP.

The PDCP processor 202 is logically connected to a user terminal under the control of the protocol processing control unit 205 to receive an IP packet from the terminal. To efficiently use a radio zone in a process of sending an IP packet to the terminal, the PDCP processing unit 202 compresses a header of the IP packet sent from the IP packet forwarding unit 203 and transmits to the FP processing unit 201. Then, the PDCP processing unit 202 extends a header of an IP packet sent from the FP processing unit 201 and transmits to the IP packet forwarding unit 203.

The packet forwarding control unit 204 controls the IP packet forwarding unit 203 according to routing control information, which is an IP packet control message sent from the transport controller 102 via the matching unit 206.

The protocol processing control unit 205 receives control information via the matching unit 20 to perform tunnel generation, release and management on the FP processing unit 201 and the PDCP processing unit 202. The control information is associated with bearer setting, which is sent from a mobility management unit and a session management unit of the access controller 101.

FIG. 5 is a block diagram of a transport controller of an IP converged mobile access gateway in accordance with an embodiment of the present invention.

The transport controller 102 includes a matching unit 304 for matching with the access controller 101, a control unit 303 for controlling the transport executor 103, a routing protocol processing unit 302, and a routing database 301.

The matching unit 304 for the matching with the access controller 101 performs matching to exchange a control message with the access controller 101.

The routing database 301 and the routing protocol processing unit 302 perform storage and management of an adjacent routing address required for routing, and routing-protocol execution to perform IP packet routing in packet forwarding of the transport executor 103. That is, the routing protocol processing unit 302 acquires routing information for the IP packet routing from the routing database 301 upon a request of the control unit 303, and sends the routing information to the control unit 303.

The control unit 303 controlling the transport executor 103 sends routing control information to the transport executor 103, and sends the mobility management information and the session management information sent from the access controller 101 via the matching unit 304 to the matching unit 206 of the transport executor 103.

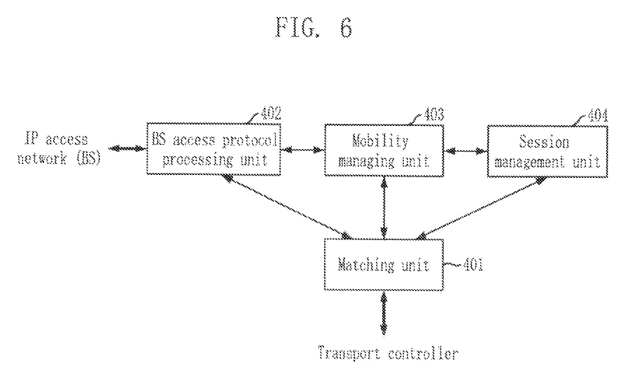

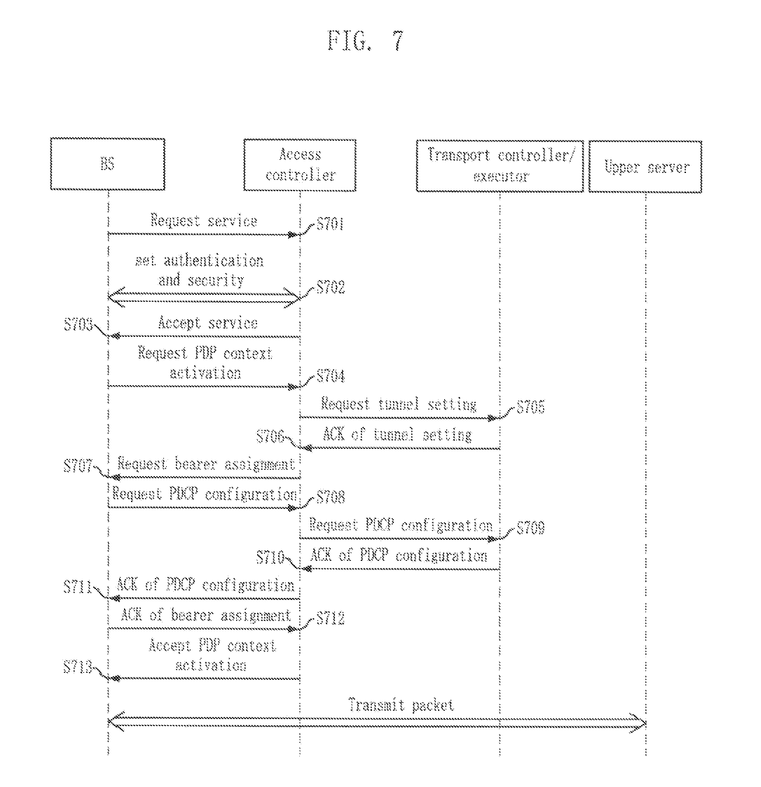

FIG. 6 is a block diagram of an access controller of an IP converged mobile access gateway in accordance with an embodiment of the present invention.

The access controller 101 includes a base station (BS) access protocol processing unit 402, a mobility management unit 403, a session management unit 404, and a matching unit 401. The BS access protocol processing unit 402 performs matching with a base station, and protocol processing. The mobility management unit 403 manages mobility such as handover of a user terminal. The session management unit 404 performs session setting, release and management required for user data transfer. The matching unit 401 performs matching with the transport controller 102.

The BS access protocol processing unit 402 processes a protocol for radio access network control application to exchange bearer-setting control information required for user data transfer between the base station and the access gateway. The BS access protocol processing unit 402 exchanges mobility management information and session management information with the base station through the protocol for the radio access network control application.

The mobility management unit 403 performs access and release with respect to a user terminal according to the mobility management information sent from the BS access protocol processing unit 402. Also, the mobility management unit 403 performs routing-area update processing of the terminal, terminal service request processing, paging processing, authentication and encoding processing, message transfer processing, and context management for a multimedia broadcasting/group transmission service.

The session management unit 404 performs service session management such as setting and closing of a session according to the session management information. Also, the session management unit 404 performs multi-session management, and management of a packet data protocol (PDP) context and a multicast broadcast multimedia service (MBMS) context. The session management unit 404 also performs session management for the multimedia broadcasting/group transmission service.

The matching unit 401 sends the mobility management information sent from the mobility management unit 403 and the session management information sent from the session management unit 404 to the transport controller 102.

FIG. 7 is a flow diagram for explaining a process of processing a service request of a terminal in an IP converged mobile access gateway in accordance with an embodiment of the present invention.

When the access controller 101 of the access gateway receives a service request of a terminal from a base station, e.g., eNode B, in step S701 after a radio resource control (RRC) connection is completed between a user terminal and the base station, the mobility management unit 403 of the access controller 101 authenticates the terminal and sets a password mode to process authentication and security of the terminal in step S702.

When the authentication and the security with respect to the terminal are completed, the access controller 101 makes a response indicating that the service request of the terminal is accepted in step S703.

Then, the terminal requests activation of a packet data protocol (PDP) context through the base station. When receiving the request in step S704, the session management unit 404 of the access controller 101 requests the transport executor 103 to set a tunnel through the transport controller 102 in step S705. Thus, the protocol processing control unit 205 of the transport executor 103 controls the FP processing unit 201 to set a tunnel with the base station. In step S706, when the tunnel with the base station is set, the transport executor 103 sends a response about the tunnel setting to the access controller 101 through the transport controller 102.

In step S707, when the access controller 101 receives a response indicating that the tunnel setting is completed, the access controller 101 requests the base station to assign a radio bearer for data transfer. When the access controller 101 receives a request for PDCP configuration from the base station in response to the request for the radio bearer assignment in step S708, the access controller 101 requests the protocol processing control unit 205 of the transport executor 103 to configure a PDCP through the transport controller 102 in step S709.

Thus, the protocol processing control unit 205 of the transport executor 103 controls the PDCP processing unit 202 to control to configure the PDCP for a logical connection to the terminal. Then, the protocol processing control unit 205 sends a result of the control to the access controller 101 through the transport controller 102.

When the access controller 101 receives a response about the PDCP configuration through the transport controller 102 in step S710, the access controller 101 sends a response with respect to the PDCP configuration to the base station in step S711. Then, the base station sets a radio bearer with the terminal, and sends a radio bearer assignment response to the access controller 101 in step S712.

When the radio bearer for data transmission is assigned, the access controller 101 informs the base station that the request for the PDP context activation is accepted. Thus, the terminal can transmit packet data via the IP core network. The packet data sent from the terminal is processed by the transport executor 103 of the access gateway. In detail, the packet data is processed and transmitted by the FP processing unit 201, the PDCP processing unit 202, and the IP packet forwarding unit 203 of the transport executor 103.

After the packet transmission is completed, the release of the radio bearer is performed in the opposite order to that described above. Detailed description thereof will be omitted.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean Patent Application Nos. 2006-0124032 and 2007-0083980, filed in the Korean Intellectual Property Office on Dec. 7, 2006 and Aug. 21, 2007, respectively, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An Internet protocol (IP) converged mobile access gateway for a third-generation (3G) mobile service, which is placed between a base station and an IP core network to provide an IP mobile service to a terminal, the IP converged mobile access gateway comprising:
an access controller adapted to exchange a control signal with the base station and perform mobility control for the terminal and session control for a service request;
a transport controller adapted to perform routing database information management and routing protocol processing for packet routing; and
a transport executor adapted to set a tunnel with the base station for user data transmission according to control information sent from the access controller, configure a packet data convergence protocol (PDCP) for a logical connection with the terminal, and interwork with the transport controller to perform packet routing and forwarding.

2. The IP converged mobile access gateway of claim 1, wherein the transport executor comprises:
a packet forwarding control unit adapted to interwork with the transport controller to control forwarding of an IP packet according to routing control information;
a protocol processing control unit adapted to perform control associated with tunnel generation and release according to control information associated with bearer setting, which is sent from the access controller;
an IP packet forwarding unit adapted to perform routing of an IP packet under the control of the packet forwarding control unit;
a framing protocol (FP) processing unit adapted to perform tunnel setting and release with the base station under the control of the protocol processing control unit and perform FP conversion for data transmission to the base station; and
a PDCP processing unit adapted to make a logical connection with the terminal under the control of the protocol processing control unit and perform compression and extension of a packet header between the IP packet forwarding unit and the FP processing unit.

3. The IP converged mobile access gateway of claim 2, wherein the IP packet forwarding unit is adapted to perform table management for packet filtering, paging reporting for a received packet, and control-message processing on a multimedia packet for broadcasting and group transmission.

4. The IP converged mobile access gateway of claim 2, wherein the FP processing unit is adapted to perform error processing of a framing protocol (FP).

5. The IP converged mobile access gateway of claim 1, wherein the transport controller comprises:
a routing database adapted to store a routing address;
a routing protocol processing unit adapted to acquire routing information for routing of an IP packet from the routing database; and
a control unit adapted to send routing control information acquired through the routing protocol processing unit to the transport executor, send control information sent from the access controller to the transport executor, and send a processing result of the transport executor to the access controller.

6. The IP converged mobile access gateway of claim 1, wherein the access controller comprises:
a base station (BS) access protocol processing unit adapted to perform protocol processing for radio-access-network control application to exchange bearer-setting control information required for user data transmission with the base station;
a mobility management unit adapted to perform mobility management with respect to a user terminal according to mobility management information sent from the BS access protocol processing unit; and
a session management unit adapted to perform session setting and closing according to session management information and send control information associated with tunnel setting and release, and control information for configuration of the PDCP to the transport executor.

7. The IP converged mobile access gateway of claim 6, wherein the mobility management unit is adapted to perform routing area update processing for a terminal, terminal service request processing, authentication and encoding processing, and context management for a multimedia broadcasting/group transmission service.

8. The IP converged mobile access gateway of claim 7, wherein the session management unit is adapted to perform management of a packet data protocol (PDP) context and a multicast broadcast multimedia service (MBMS) context, and session management for the multimedia broadcasting/group transmission service.

9. A service method using an Internet protocol (IP) converged mobile access gateway placed between a base station and an internet protocol (IP) core network and having an access controller, a transport controller and a transport executor, comprising:
at the access controller, performing authentication and security setting in response to a service request of a terminal;
at the access controller, requesting the transport executor to set a tunnel in response to a context activation request;
at the access controller, requesting the base station to assign a bearer when a tunnel is set at the transport executor;
at the access controller, requesting the transport executor to configure a packet data convergence protocol (PDCP) for a logical connection with the terminal in response to a PDCP configuration request of the base station; and
at the access controller, sending a PDCP configuration response to the base station, and reporting that the context activation request is accepted when a bearer assignment response is received from the base station.

10. The service method of claim 9, further comprising the step of:
at the transport executor, performing routing of a packet being transmitted, by interaction with the transport controller after the step of sending the PDCP configuration response.

11. The service method of claim 9, wherein the access controller exchanges control information with the base station through a protocol for radio network application.
